(19) United States
(12) Patent Application Publication
(10) Pub. No.: US 2003/0104781 A1
(43) Pub. Date: Jun. 5, 2003

(54) Modular residential radio frequency converting repeater

(76) Inventor: O. Sung Son, Granada Hills, CA (US)

Correspondence Address: Vincent Lee, 2607 Colorado Boulevard, Los Angeles, CA, 90041, US

(21) Appl. No.: 09/998,238

(22) Filed: Dec. 3, 2001

(51) Int. Cl. H04B 7/14

(52) U.S. Cl. 455/22; 455/15; 455/20

(57) ABSTRACT

The present invention aims to improve poor cellular reception at home with minimum cost and extreme ease. In order to avoid the oscillation problem and to acquire proper antenna isolation, traditional residential repeaters consist of an indoor repeater unit and an outdoor antenna wired to the indoor repeater. This design makes installation difficult and cumbersome. In addition, signal loss along the cable is inevitable.

By employing two modular repeaters, the present invention eliminates wires in a residential repeater. Two modular repeaters communicate simultaneously with each other with low radio frequency. Since the present invention does not have wire, installation is simple and easy.

The present invention enables seamless connection between home and a nearby base station or repeater, which means improved cellular reception, less dropped calls and more revenue for the service providers without building costly base stations.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO MICROFICHE APPENDIX

NOT APPLICABLE

### BACKGROUND OF THE INVENTION

1. Field of the Invention

Despite the cellular phone service providers' relentless efforts to reduce shade areas by diligent cell surveys and construction of more base stations and repeaters, cellular phone subscribers' complaints about poor cellular reception or dropped calls seem to be far from diminishing. This poor reception problem is exacerbated when subscribers use their cell phones in their homes, especially in the metropolitan area where tall skyscrapers and multi-story apartment buildings are densely located.

Nevertheless, there are more and more people using cellular phones at home. Despite poor reception, some people find it convenient to be reached at one number wherever they are, that is, at work, at home or outdoors. Some people find it uneconomical to pay for both cellular and land line services and simply want to take advantage of free night and weekend minutes that many cellular service providers competitively offer. There is a growing number of people who are eliminating land line service completely at home and use only cellular or who are eliminating a second land line and replacing it with a cellular phone.

Because more airtime translates into higher revenues for cellular service providers, they are eager to improve the quality of their service by building more base stations, repeaters and cell towers. These efforts were, in general, successful in increasing outdoor cell coverage. However, they do not effectively cure the poor quality problem in the case of indoor cellular phone use. The failure lies in the fact that they are essentially designed to increase outdoor cell coverage not to improve indoor cellular quality. In addition, base stations and repeaters are very expensive to build and maintain. To sum up, building more base stations and repeaters is neither effective nor economical to reach every cellular user's living room.

Therefore, there is a soaring need for small indoor relay systems (“residential repeaters”) that connects seamlessly between a cellular user's home and service provider's outdoor repeater or a base station nearby.

2. Description of the Prior Art

A few residential repeaters have been introduced into the market in an attempt to address the problem of poor cellular reception quality at home. However, ironically, none has been popularized among cellular users despite the soaring need. The need remains unmet.

One of the reasons why all residential repeaters failed to become popular lies in the inherent problem of implementing repeater technologies in a small package. A repeater has two antennae, i.e., base station-facing antenna and mobile-facing antenna. Maintaining the proper isolation between the base station-facing antenna and the mobile-facing antenna is essential to the proper functioning of a repeater. That is because, without the proper isolation, the amplified signal which is sent out through the mobile-facing antenna feeds back to the base station-facing antenna and the signal is re-amplified causing oscillation.

Therefore, to ensure the proper isolation between the two antennae, all residential repeaters currently available on the market are comprised of two or three units: an outdoor antenna, a repeater unit, and an indoor antenna; or an outdoor antenna and a repeater equipped with an indoor antenna. With these systems, wiring is necessary between the antennae and the repeater, which makes installation difficult and costly. In addition, in the case where one should implement a long cable, signal loss along the cable is inevitable.

### SUMMARY OF THE INVENTION

The present invention, Modular Residential Radio Frequency Converting Repeater, solves a seemingly incompatible design conflict between (1) acquiring proper isolation and (2) reducing size and eliminating wire. Rather than dividing a residential repeater into an outdoor antenna and an indoor repeater unit, this invention takes a modular approach, that is, two modular repeater units. One is an outdoor modular repeater communicating with a base station and the other is an indoor modular repeater communicating with a mobile phone unit. The two modules communicate with each other with converted radio frequency.

Upon receiving signals from a base station, for example, at 1930-1990 MHz, the outdoor module, after low noise amplification and filtering, relays signal at 180-240 MHz to the indoor module through frequency down converting. After receiving the 180-240 MHz converted signal, the indoor module recreates the original 1930-1990 MHz signal through low noise amplification, filtering, and frequency up converting and then sends it to a mobile phone.

Up link is basically in the reverse order. A 1850-1910 MHz signal transmitted from a mobile phone is received from the indoor module. Then through low noise amplification, filtering and frequency down converting, the indoor module relays a signal at 100 MHz-160 MHz to the outdoor module. Receiving the down converted signal, the outdoor module recreates the signal at 1850-1910 MHz through low noise amplification, filtering, and frequency up converting and then transmits the recreated signal to a nearby base station.

By having two modular repeaters communicating with each other with low radio frequency, this invention bypasses the oscillation problem by acquiring enough isolation between the antennae. In addition, because the two modular repeaters communicate with each other with low radio frequency, the present invention eliminates wiring between conventional outdoor antenna and indoor unit, and reduces signal loss.

### BRIEF DESCRIPTION OF THE DRAWINGS

For a better understanding of the principle and nature of the present invention, references should be made to the following detailed descriptions taken in consideration with the accompanying drawings in which:

FIG. 1 is a diagram showing all the elements of traditional radio frequency repeater.

FIG. 2 shows the oscillation phenomenon due to not having enough isolation between two antennae.

FIG. 3 is a layout of a traditional residential repeater comprising of an outdoor antenna wired to an indoor repeater unit.

FIG. 4 is a layout of the present invention.

FIG. 5 is a diagram showing all the elements of an outdoor module of the present invention.

FIG. 6 is a diagram showing all the elements of an indoor module of the present invention.

### DETAILED DESCRIPTION OF THE PREFERRED EMBODIMENT

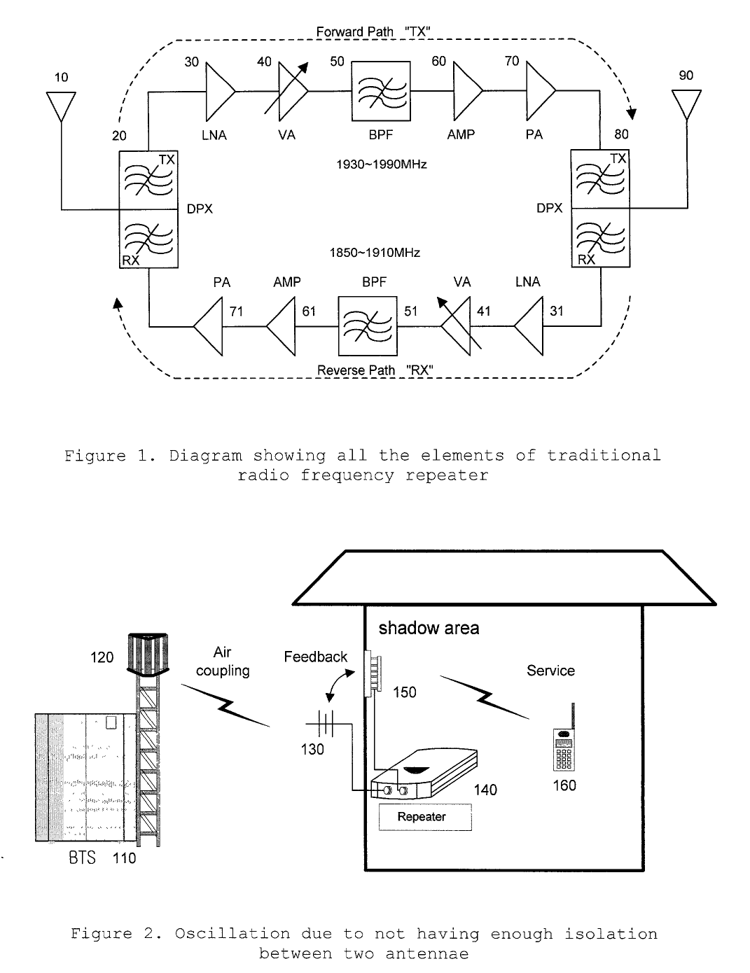

FIG. 1 is a diagram of a typical radio frequency repeater. It illustrates both the Forward Path (TX) and the Reverse Path (RX) that the signal travels inside a traditional repeater to and from a base station and a mobile unit. TX is as follows:

Base station-facing antenna 10 receives a signal. Through duplexer (DPX) 20, the signal is sent to TX. Low Noise Amplifier (LNA) 30 sorts out the noise and amplifies the signal. Variable Amplifier (VA) 40 adjusts the forward path gain. Band Pass Filter (BPF) 50 filters the signal and both Middle Amplifier 60 and Power Amplifier 70 amplify the signal. The amplified signal is sent to DPX 80 and finally the signal is transmitted to the air through mobile-facing antenna 90.

RX is basically in the reverse of TX. RX is as follows:

The signal received by mobile-facing antenna 90 is sent to RX through DPX 80. LNA 31 sorts out noise, amplifies the signal and then sends the signal to VA 41. VA 41 adjusts the forward path gain. BPF 51 filters the signal. Both AMP 61 and PA 71 amplify the filtered signal. The amplified signal is sent to DPX 20 and then transmitted to a base station through base station-facing antenna 10.

FIG. 2 illustrates the oscillation problem in a typical RF repeater 140 when the two antennae 130 & 150 are not isolated properly. As FIG. 2 illustrates, without proper isolation, the signal transmitted from the mobile-facing antenna 150 feeds back to the base station-facing antenna 130. The latter antenna 130 picks up the already amplified signal and sends the amplified signal back to the repeater 140. This feedback and re-amplification process continues causing harm to the repeater 140 and signal loss to the mobile unit 160.

Acquiring proper isolation to avoid the oscillation has been the major hurdle in embodying a small residential repeater that has the two antennae and other RF components all in one small box. Therefore, the traditional radio frequency residential repeaters simply detach a base station-facing antenna as an outdoor unit from the repeater. However, by separating the base station-facing antenna this way, the detached antenna and the other unit must be wired by cable and suffer signal loss along the way. In addition, wiring is difficult and cumbersome and, therefore, works as a disincentive for home users.

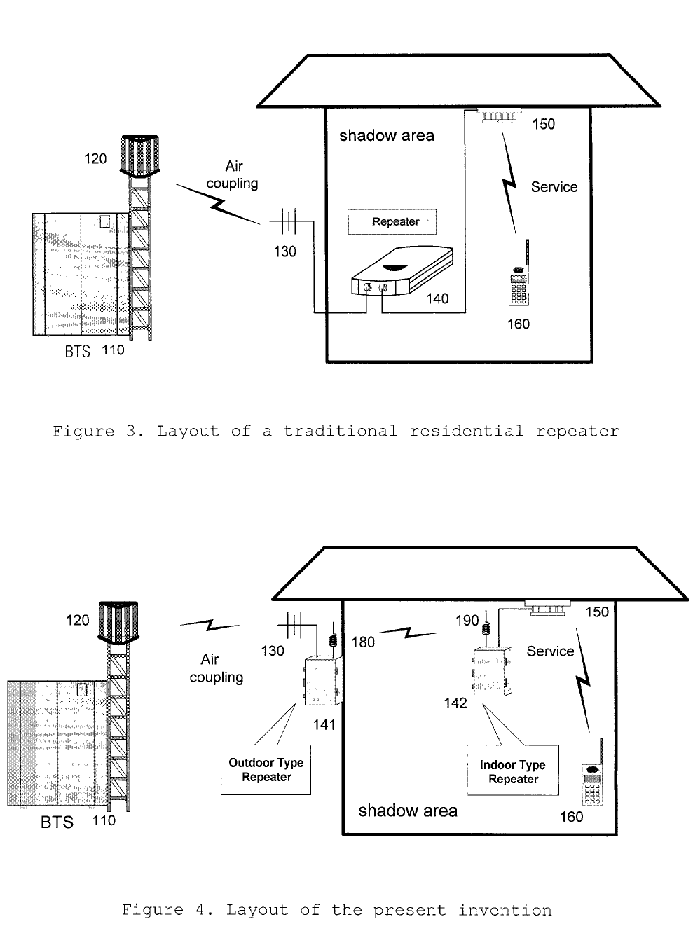

FIG. 3 illustrates the simplest solution to acquire proper isolation between the antennae by maintaining sufficient distance between the base station-facing antenna 130 and the mobile-facing antenna 150. With this layout, oscillation can be effectively avoided since the transmitted signal from the mobile-facing antenna 150 does not feed back to the base station-facing antenna 130. However, the two antennae 130 & 150 must be wired by a long cable and signal loss along the way is inevitable. In addition, installing an outdoor antenna can be a hurdle for many prospective residential repeater users.

FIG. 4 is a simple layout of the present invention. In order to solve the oscillation problem without using an outdoor antenna wired to an indoor unit, the present invention divides a repeater into two modular repeaters and allows the two modules to communicate simultaneously with down converted radio frequency.

Regarding the TX of the signal transmitted from base station 110, the signal is received by a base station-facing antenna 130 attached to an outdoor modular repeater 141. The outdoor modular repeater 141 down converts the signal and delivers it to the indoor modular repeater 142 through indoor module-facing antenna 180. The down converted signal is received by the indoor modular repeater 142 through outdoor module-facing antenna 190. The indoor modular repeater 142 up converts the down converted signal. The recreated original signal is delivered to mobile unit 160 through the mobile-facing antenna 150.

The RX from the mobile unit 160 to base station 110 is as follows:

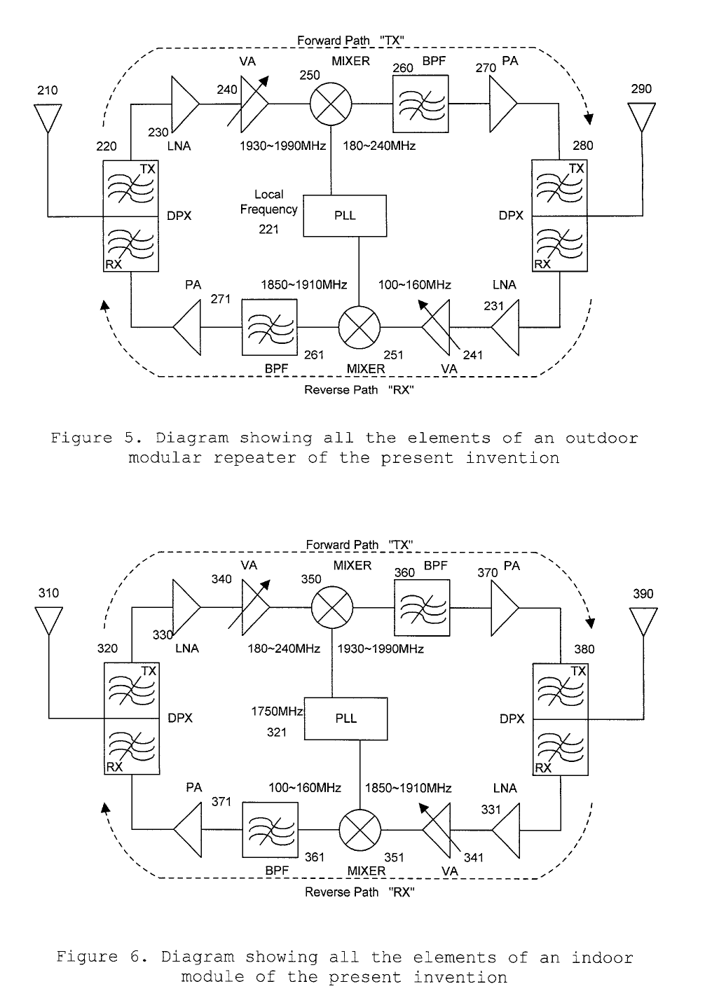

The mobile unit 160 transmits signal. The indoor modular repeater 142 picks up the signal through mobile unit-facing antenna 150. The indoor modular repeater 142 down converts signal and delivers it to outdoor modular repeater 141 through outdoor module-facing antenna 190. The outdoor modular repeater 141 picks up down converted signal through indoor module-facing antenna 180. The outdoor modular repeater 141 recreates original signal by up converting the down converted signal and sends it out to the base station 110 through the base station-facing antenna 130. The work of both indoor and outdoor modular repeaters is explained in more detail in FIGS. 5 and 6 respectively.

FIG. 5 illustrates the elements of an outdoor module of the present invention. How it works is as follows: Base station-facing antenna 210 receives a weak signal from the base station. This signal is delivered to LNA 230 through TX port in DPX 220. LNA 230 sorts out noise, amplifies the signal, and sends it to VA 240. VA 240 adjusts the signal gain produced during the path. Mixer 250 down converted the signal to 180-240 MHz by mixing the 1930-1990 MHz signal from VA 240 and 1750 MHz local signal produced at Phase Locked Loop (PLL) 221. BPF 260 filters the down converted signal (180-240 MHz, Band Width=60 MHz) and eliminates spurious images and signal. PA 270 amplifies the signal. The signal is transmitted to the indoor modular repeater through DPX 280 and indoor module-facing antenna 290.

The RX of the outdoor module is the same as the TX but in a reverse order through the RX Path.

FIG. 6 is a diagram of an indoor module of the present invention. The way it works is as follows: The outdoor module-facing antenna 310 receives the down converted signal (180-240 MHz) from the outdoor module. The signal is delivered to LNA 330 through TX port of DPX 320. LNA 330 sorts out the noise, amplifies the signal and then sends it to VA 340. VA 340 adjusts the gain produced along the TX. Mixer 350 recreates the original signal received from the base station-facing antenna 210 in the outdoor module by mixing the down converted signal with the 1750MHz local signal produced from PLL 321. BPF 360 filters the up converted signal (1930-1990 MHz, BW=60 MHz) and eliminates spurious images and signal. PA 370 amplifies the filtered signal. The signal is transmitted to the mobile unit through the TX port of DPX 380.

The RX of the indoor module is the same as the TX above but in the reverse order through the RX path.

What is claimed as being new and therefore desired to be protected by Letter Patent of the United States is as follows:

1. A modular residential radio frequency converting repeater for both PCS (1,850-1,990 MHz) and DCS (824-894 MHz) systems comprised of the following:
(a) An outdoor modular repeater and an indoor modular repeater.
(b) Two modular repeaters communicating simultaneously with each other with converted low radio frequencies.
